(19) United States
(12) Patent Application Publication
(10) Pub. No.: US 2014/0184854 A1
(43) Pub. Date: Jul. 3, 2014

(54) FRONT CAMERA FACE DETECTION FOR REAR CAMERA ZOOM FUNCTION

(71) Applicant: MOTOROLA MOBILITY LLC, Libertyville, IL (US)

(72) Inventor: Yuriy S. Musatenko, Kyiv (UA)

(73) Assignee: MOTOROLA MOBILITY LLC, Libertyville, IL (US)

(21) Appl. No.: 13/729,211

(22) Filed: Dec. 28, 2012

(51) Int. Cl. H04N 5/232

(52) U.S. Cl. CPC H04N 5/23296
USPC 348/240.2

(57) ABSTRACT

A method is described herein for controlling a zoom mode function of a portable imaging device equipped with multiple camera modules, such as a dual camera imaging device like a digital still camera, a smart phone, a tablet or a camcorder. Including, a method for enabling an automatic zoom mode operation for one of the camera modules is described based on the size of an identified user's face or based on at least one of the user's facial features as detected by a front-facing camera module. In response to detecting the size of the user's face or of his or her facial features, a zooming coefficient for the rear-facing camera module is automatically determined as the user moves the imaging device closer or farther away from his face.

### TECHNICAL HELD

The disclosed teachings herein pertain to electronic devices equipped with imaging sensors. More specifically, the electronic devices are equipped with multiple imaging sensors, which are located in the front of the device as well as in the rear of the electronic device.

### BACKGROUND

Many handheld electronic devices are equipped with imaging sensors, such as smartphones, wearable computers and tablet computers; and thus may be considered as imaging devices in theft own right along side traditional or single purpose digital cameras. These imaging devices are often equipped with at least two camera modules. A front facing first camera module (i.e., “front camera”) is typically disposed on the same side as a display screen of the imagining device and faces the user during normal user interactions with the imaging device. A second camera module, the rear facing camera module (i.e., “rear camera”), is installed on a rear side of the imaging device facing in the direction away from the user during normal user interactions with the imaging device. Both camera modules are never used concurrently or in conjunction with each other. While the back facing camera module captures a desired image, which is subsequently displayed on the display screen of the imaging device, the front camera module is typically switched off and vice versa.

The imaging devices provide several mechanical, electrical and/or software controls responsive to the users touch and allowing the user to interact with and control the imaging device. The user will typically operate such controls before, during and after he captures the desired image. For example, as the user attempts to capture the desired image or a video, he will first use a specialized set of controls, e.g. buttons or graphical icons, to adjust the zoom of the imaging device to identify a desired view, while a given camera module operates in the viewfinder mode and then, once satisfied with the displayed image, record such image by interfacing with yet another set of controls. Furthermore, while capturing the desired image, the user is forced to switch his focus or gaze away from the viewfinder and onto various available controls presented by the imaging device, such as zoom controls, to continue maintaining a desired angle of view. Constantly changing focus to identify and select the appropriate controls becomes extremely inconvenient and distracting to the common, non-professional image device user.

### BRIEF DESCRIPTION OF DRAWINGS

FIG. 1 illustrates, by way of example, a system diagram for an imaging device.

FIG. 2 illustrates positional locations for the imaging device in relation to a user.

FIG. 3 shows an example flowchart.

FIG. 4 shows another example flowchart.

FIG. 5 shows an example block diagram.

### DETAILED DESCRIPTION

In accordance with one or more embodiments described herein as example teachings are methods for controlling a zoom mode operation of a portable imaging device equipped with multiple camera modules, such as a dual camera imaging device like a digital still camera, a smart phone, a tablet or a camcorder. In one embodiment, a method for enabling an automatic zoom mode operation for one of the camera modules is described based on the size of an identified user's face or based on at least one of the user's facial features as detected by a front-facing camera module. In response to detecting the size of the user's face or of his or her facial features, a zooming coefficient for the rear-facing camera module is automatically determined as the user moves the imaging device closer or farther away from his face.

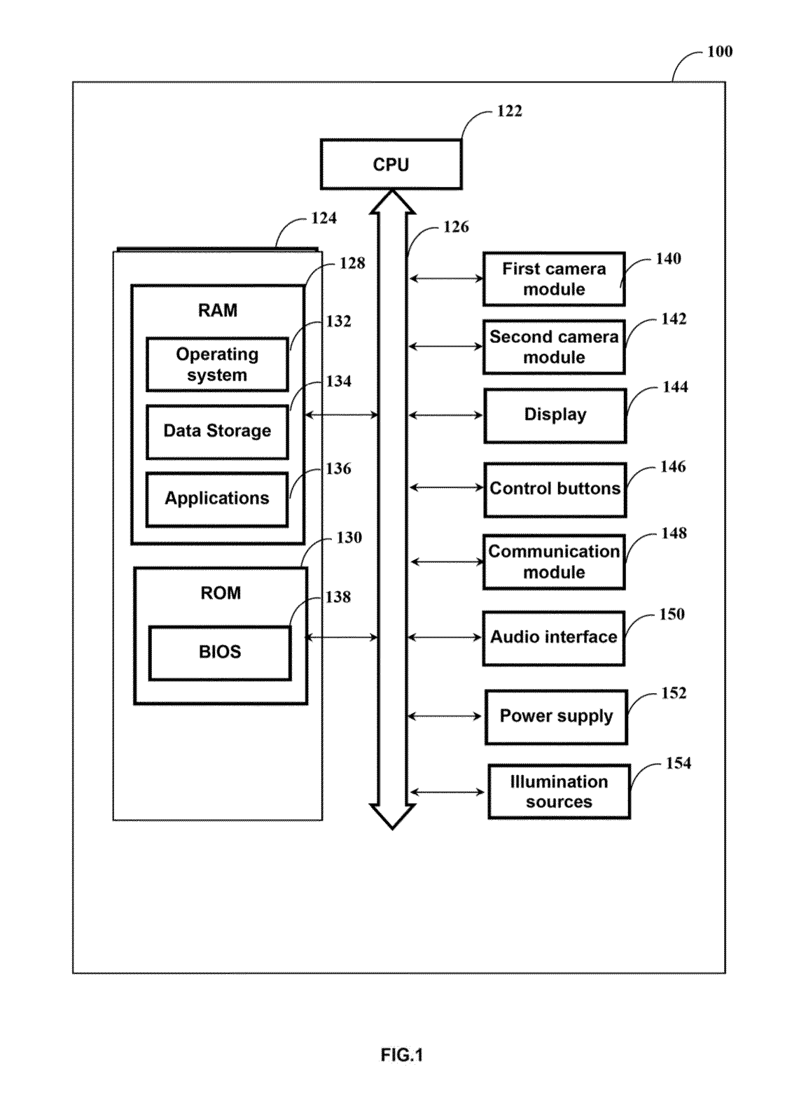

FIG. 1 depicts an example structure of a portable imaging device 100 such as electronic devices that include imaging sensors, for example, a smartphone, a wearable computer, a cell phone, PDA, a tablet computer, as well as a multi-camera camcorder, a laptop, a palmtop, a hand-held computer and the like in which the described embodiments are implemented. As shown, the imaging device 100 includes a central processing unit (CPU) 122 connected to a main memory 124 using a data bus 126. The main memory 124 represents a storage media to store an operating system 132, various applications 136, as well as data, such as user and temporary data generated and used during execution of various applications 136, as well as other information. Main memory 124 may include a random access memory (RAM) 12$, a read only memory (ROM) 130 or any other suitable volatile or non-volatile memories, such as cache memory or a permanent data storage memory 134 (e.g. one or more optical disks, hard drives, magnetic or floppy disks and one or more removable flash memories).

The imaging device 100 also includes several image acquisition modules represented by at least two camera modules 140 and 142 in the exemplary embodiments and coupled to the bus 126. CPU 122 executes one or more dedicated applications 136 stored in the main memory 124 and independently controls each of the camera modules to capture and process still and/or moving images, in real-time, and according to predetermined image-processing algorithms contained within such applications 136. Once processed, still or motion images will then be displayed on the screen of a display 144.

In accordance with one embodiment, the first camera module 140 may be arranged in such a manner that its lens and the display 144 are co-located on the same front cover or housing (not shown) of the imaging device 100, capturing the user's face in its field of view when the user holds and interacts with the imaging device 100. Simultaneously, a lens of the second camera module 142 may be disposed on the back cover or housing (not shown) of the portable imaging device 100 and directed opposite to the field of view of the first camera module 140.

Each of the camera modules, 140 and 142, as shown in FIG. 5 may include a zoom lens assembly 500, an imaging device 501 and a Digital Signal Processor (DSP) 502 to execute appropriate digital signal processing algorithms for processing captured images. The zoom lens assembly 500, if included as part of the camera module, is a mechanical assembly of lenses for which the focal length can be varied. The imaging device 501, may be implemented by a CCD imaging sensor, CMOS Imaging sensor, or a similar solid-state imaging device, including millions of light sensitive pixels and an RGB (red, green and blue) color filter (not shown) positioned on the light sensitive surface of such imaging device. As the CCD sensor, for example, generates an RGB color image of a desired scene, it is fed to and is subsequently processed by the image-processing algorithms executed by DSP 502 before being displayed to the user. The image-processing algorithms can including, but not limited to, tonality correction, color correction, digital noise reduction, image-stabilization, color-space transformation, digital zoom, compression, color mode transformation and encoding algorithms. The DSP 502 may be a single integrated chip or may be combined with the CPU 122 of FIG. 1, for example.

One of the signal processing algorithms executed by the DSP 502 is a digital zoom algorithm used to decrease an apparent angle-of-view, most often referred to as field-of-view, of a captured still or video image and to emulate the effect of a longer focal length zoom lens (narrower angle-of-view). Digital zoom algorithms may be implemented by cropping the images, captured by the CCD sensor, around its center area, while continuing to maintain the same aspect ration as the original image, and then, interpolating the resulting cropped image back to the pixel dimensions of the original image to be later recorded as a captured image or presented to the user on the screen of the display 144 during, for example, a viewfinder mode of operation for the imaging device 100.

On the other hand, an optical zoom function is a method which allows the user to very the focal length of the lens within the mechanical lens assembly 200 and determine a photo angle-of-view before capturing a still or a moving image. Nonetheless, both the digital and the optical zoom functionality are commonly available in portable devices sold and manufactured today, and in some products may be combined with each other.

Display 144 may be an LCD, an LED, a projection, transparent or any other type of display used to display information, in a graphical or image format, in a portable device. Images captured by the camera modules 140 and 142 are routed by CPU 122 to be displayed on the screen of the display 144 in response to commands generated by control buttons 146. The control buttons 146 may be arranged across the surface of the portable imaging device 100 and are either disposed on the housing of the device or outlined as graphical icons as part of the graphical user interface presented to the user on the touch sensitive display 144. In any case, the set of control buttons 146 may enable any desired command associated with the selection and execution of the required mode of operation.

In addition, the imaging device 100 may contain a communication module 148 that includes circuitry for coupling the imaging device 100 to one or more wireless networks and is compatible with one or more communication protocols and technologies including, but not limited to, TCP, SMS, GPRS; WAP, TCP/IP, CDMA, GSM, TDMA, FDMA. WiMAX and others.

An audio interface 150 is arranged in the portable imaging device 100 to produce and/or receive audio signals such as voice; music and the like; and is coupled to a speaker, headset and a microphone (not shown) to allow the user to communicate with others.

A power supply 152 that may include a rechargeable or a non-rechargeable battery powers every component of the imaging device 100. Furthermore, the power to the imaging device 100 may in addition be supplied by an AC adapter or a powered docking station that supplements and/or recharges the rechargeable battery.

Optionally, the portable imaging device 100 may comprise at least one, but preferably a set of illuminating sources 154 that illuminate objects in front of the appropriate camera module 140 and/or 142 when images are being captured.

A person having ordinary skill in the art of electronic imaging devices will readily recognize other hardware and software components that may comprise the portable imaging device 100 of the current disclosure. For example, imaging device 100 may include a GPS module for determining its current position. Location coordinates calculated by the GPS module may be used to provide tracking of the imaging device 100 with millimeter accuracy. In addition to using satellite signals, the GPS module may also employ other alternative or supplemental geo-positioning mechanism, including, but not limited to, triangulation, aGPS, cell identifier, or the like, for facilitating determination of device's coordinates. In addition, the portable imaging device 100 may also include motion, speed, acceleration, current spatial position and orientation sensors, such as but not limited to accelerometer, gyroscope, compass and other positional sensors, to assist the GPS module in accurately calculating a position or location of the imaging device 100.

Generally, the portable imaging device 100 may include many more, or alternatively fewer components than those shown on FIG. 1. However, the components shown are sufficient to disclose and illustrate the embodiments of the teachings herein to persons having ordinary skill in the art of electronic imaging devices.

One or more embodiments are described below regarding the example structure of the portable imaging device 100. A method or operation is described for the portable imaging device 100 to automatically adjust the zooming coefficient associated with either the optical and/or digital zoom modes and applied when capturing still or moving images.

At least one feature of the disclosed embodiments includes a simultaneous use of at least two camera modules for capturing images with the portable imaging device 100. One of the camera modules is used to capture and estimate the size of a user's face or of at least one of his corresponding facial features. Once the size, for example, of the user's face is determined, the facial size is used to automatically control the zoom of the second camera module responsible for capturing a desired scene.

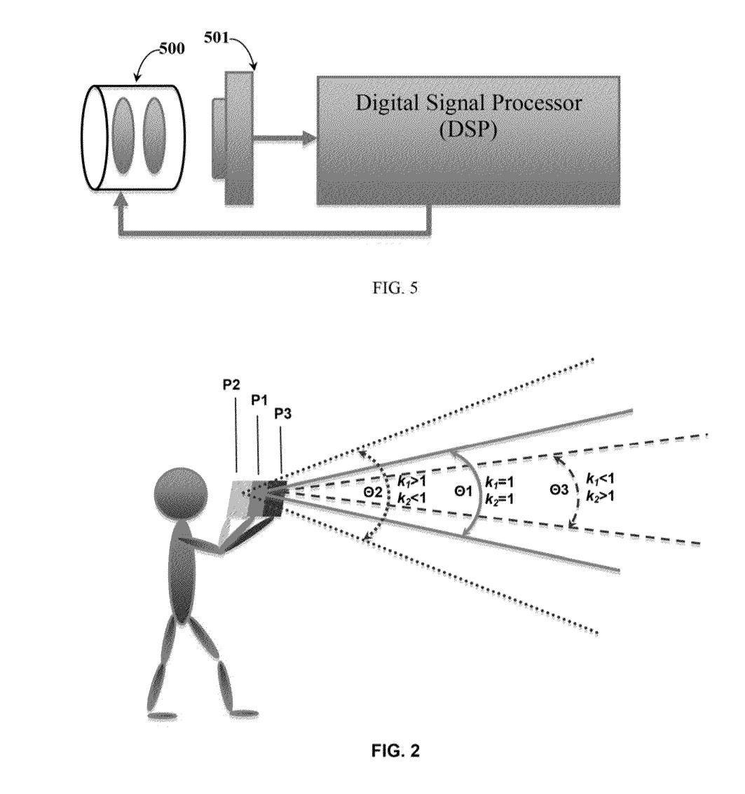

FIG. 2 illustrates a general approach used as part of the disclosed embodiments depicting a portable imaging device 100 which includes the first (front) and the second (rear) camera module, 140 and 142, respectively, and is placed at position P1 to begin the process of identifying and capturing still or moving images. Once at position P1, the portable imaging device 100 is moved either to position P2 which is closer to the user's head or to position P3 which is further away from the user's head to control the zoom operation of the second camera module 142 based, for example, on the size of user's face detected by the first camera module 140. The first or front-facing camera module may also be used to detect a facial feature and its corresponding size and distance to a lens of first camera module 140.

Once the portable imaging device 100 is placed at the initial position P1 it enables an automatic zoom mode for the second camera module 142 based on the facial detection, either in response to the user's activation of the special buttons 146, detecting a special touch or motion based gesture performed by the user, or identifying a selection of a desired application in a menu bar. The user's face is detected by the first camera module 140, its initial size or at least one of the facial features is calculated by CPU 122 and is equated to the initial zooming coefficient applied by the second camera module 142 as the images are captured. Based on the initial size of the facial image, CPU 122 controls the portable imaging device 100 to display and/or record captured images proportional to an angle of view, θ1.

As the user moves the portable imaging device 100 away from his head, for example, in the direction from position P1 to position P3; therefore, decreasing the size of the identified user's face as detected by the first camera module 140 beyond a certain threshold; CPU 122 controls the portable imaging device 100 to display and/or record captured images now proportionally to a reduced angle of view of θ3, as outlined by the dashed lines in FIG. 2. Accordingly, objects that are captured and displayed as images become visually magnified in size (i.e., zoomed-in) during a video capture, for example. The magnification may also work in a view finder mode for the portable imaging device 100.

When the user moves the portable imaging device 100 closer to his head from the position P1 to the position P2, resulting in the size of the detected user's face being Increased above a certain threshold, CPU 122 controls. the portable imaging device 100 to display and/or record captured images proportional to the angle of view of θ2, as outlined by dotted lines in FIG. 2. Accordingly, objects that are captured and displayed as images become visually reduced in size (i.e., zoomed-out) during video capture or view finder modes.

While automatically adjusting the zoom of the portable imaging device 100, either as part of the digital and/or optical zoom modes, the user continuously observes the image captured by the second (rear-facing) camera module 142 on the display screen of the display 144 and may, at any time, initiate a snapshot or start a video capture once a desired angle or field of view is identified. On the other hand, once an appropriate zoom level is reached, the user can exit the automatic zoom mode through selecting an application menu, performing a predetermined touch or motion gesture, or selection a special button or graphical icon.

In accordance with one embodiment, the display 144 of the portable imaging device 100 operates like a magnifying glass. The closer to the studied object the portable imaging device 100 is placed, compared to its initial position, the large the size of said studied object is as it is being displayed on the display 144 and vice versa. This process may be expressed by a zooming coefficient k that represents a ratio of linear dimensions of a certain i-component of an image in current and initial frames captured by first (front-facing) camera module 140 during the automatic zoom mode.

For example, if the portable imaging device 100 in FIG. 2 remains at the initial position P1, the size of objects captured by the imaging devices of the first and second camera modules 140 and 142 remain unchanged, resulting in the corresponding zooming coefficients k₁ and k₂, to equal one another, for example, k₁=k₂=1.

Furthermore, once the portable imaging device 100 is moved into position P3, the size of a user's face, as identified by the first imaging device of the first camera module 140, decreases compared to its size identified at position P1, which corresponds to the zooming coefficient k₁<1 for all images captured by the first camera module 140 and k₂>1 for all images captured by the second camera module 142. On the other hand, as the size of user's face identified by the first camera module 140 increase as the portable imaging device 100 moves to position P2, the zooming coefficient k₁ increase and corresponds to k₁>1 causing the zooming coefficient IC₂ to decrease and correspond to k₂<1, as k₂ is being applied to all images captured by the second camera module 142.

In other words, the zooming coefficient, applied to all images captured by the second camera module 142, is in direct relationship to the distance between the portable imaging device 100 and the user's head. As the distance is increased, the zooming coefficient is also increased causing the image displayed on the display 144 to be magnified. Meantime, anyone skilled in the art can recognize that the inverse zooming order may also be easily realized using appropriate software.

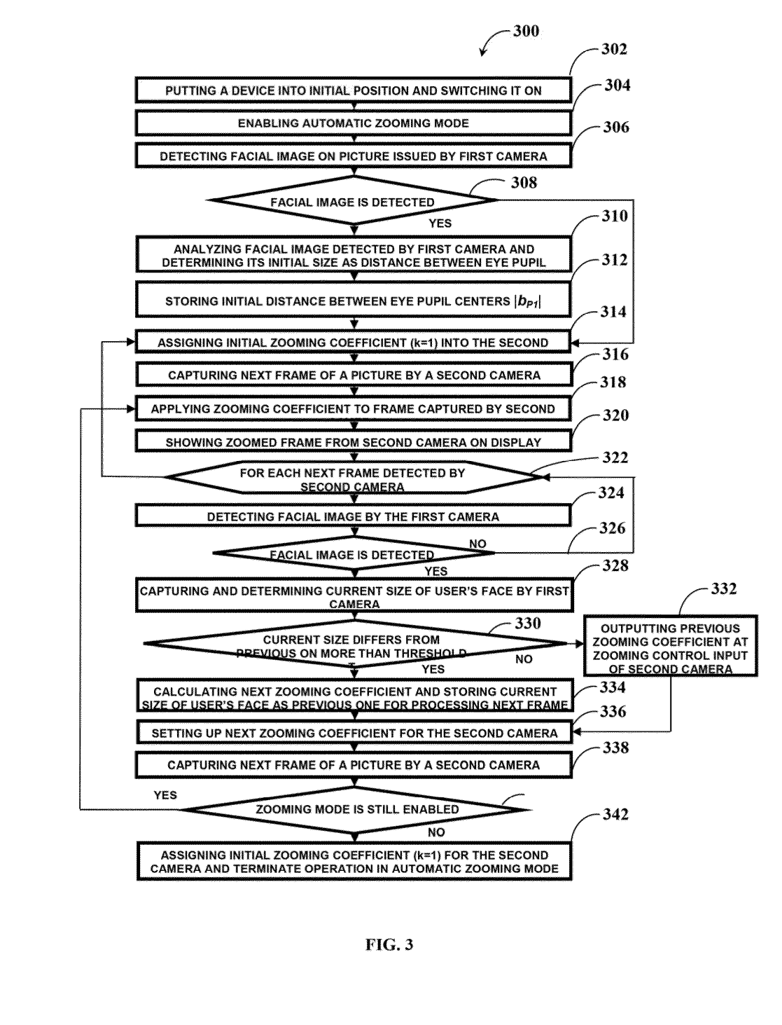

FIG. 3 illustrates one possible implementation of a method 300 for automatically zooming an image captured by the second camera module 142 of the portable imaging device 100 using the size of the user's face or of a facial feature detected by the first camera module 140. The method disclosed is described with reference to the corresponding components shown in FIG. 1 and FIG. 2.

The method 300 commences with a placement 302 of the portable imaging device 100 at the initial position designated as P1 in FIG. 2 and chosen by the user to capture images containing the studied objects of interest to the user. Optionally, the portable imaging device 100 may be switched on at this point, however it may also be done just prior to being placed at the designated position P1. Next, the user enables 304 the automatic zoom mode operation of the portable imaging device 100 pressing a button, performing a touch or a motion based gesture or selecting a menu item displayed on the touch sensitive display.

In this automatic zoom mode of operation, both the first camera module 140 (directed to the user's face) and the second camera module 142, (directed outward), are switched on simultaneously. The first camera module 140, disposed directly in front of the user's head, captures an image inclusive of the user's face and detects 306 the face among other ambient objects.

In one embodiment, CPU 122 uses an appropriate program(s) 136 stored in RAM 128 to detect 306 the user's face in the image captured by the first camera module 140. Specifically, this program(s) may operate based on a well-known “AdaBoost” (Adaptive Boosting) algorithm (P.Viola and M.Jones, “Robust real-time object detection,” In Proc. of IEEE Workshop on Statistical and Computational Theories of Vision, pp. 1-25, 2001) incorporated by reference herein. According to this algorithm, the rectangles covering a quasi-frontal face in the image are defined and then, the face position is determined more precisely within the limits of each previously defined rectangle. Such determination may be based on the detection of the distance between the centers of the pupils of the user's eyes and performed according to an algorithm, which uses a large number of captured eye images. Experiments have shown that this is a reliable method for the detection of the distance between the centers of the pupils of the user's eyes in the facial images even when the faces are oriented differently and the eyes are narrowed or dosed.

If the detection 306 of the facial image in the image captured by the first camera module 140 is confirmed by a conditional block 308, the first camera module 140 passes the captured image frame to CPU 122 for determining and analyzing 310 the initial size of the user's face or the initial size of the user's one or more facial features.

According to one possible embodiment, the size of facial image may be represented by a modulus of a vector b connecting eye pupils' centers and can be measured according to “AdaBoost” algorithm used for face detection. In this case, at block 310, CPU 122 measures and outputs a value of a vector modulus |bP1| equal to the distance between the eyes' centers in a facial image captured by the first camera module 140 when the portable imaging device 100 is placed at position P1.

CPU 122 stores 312 the measured value of |b_{P1}| in the data storage 134 and generates a corresponding control signal for the second camera module 142. The control signal may be generated as either RF, electrical or an optical signal, or take on other forms representing combination of oscillation and/or de voltage signals, and contain information representing a zoom coefficient to be used for processing the next image frame captured by the second camera module 142.

Since the value of the vector modulus |b_{P1}| unambiguously characterizes the size of the user's face captured by the portable imaging device 100 at initial position P1 (FIG. 2), it corresponds to the initial zoom coefficient k₂=1 and is transmitted to the second camera module 142. Once the zoom coefficient is received and setup 314 by the second camera module 142, the second camera module 142 captures 316 the next image frame and applies 318 such zoom coefficient k₂ to the captured image frame under the control of CPU 122. Resulting image is displayed 320 to the user on display 144.

Returning to the conditional block 308, if the facial image is not detected by the first camera module 142 for any reason, for example, due to shadowing or bad lighting, blocks 310 and 312 are skipped and the control signal including the zooming coefficient k₂=1 is directly transmitted or assigned 314 to the second camera module 142.

Furthermore, for each subsequent frame detected 322 by the second camera module 142, face detection provided by the first camera module 140 is checked and, if the user's face remains undetected 324 again, conditional block 326 keeps the zoom coefficient k₂=1 unchanged for the second camera module 142 and execution returns to block 314.

On the other hand, if the facial image is detected 324, the first camera module 140 captures 328 the user's facial image and computes the current size of user's face by determining 328 the distance between the user's eyes |b_{Pi}|, for the current position i-of the portable imaging device 100. Then, CPU 122 compares such distance measured at current position i with the value obtained at the initial position P1, and calculates the difference between such values using the following formula

If the calculated difference |αᵢ| exceeds a predetermined threshold T, conditional block 330 is then satisfied and CPU 122 proceeds to calculate 334 the next zoom coefficient for the i-th frame captured by the second camera module 142 using, for example, the following formula

kᵢ=M·(|B_{Pi-1}|/|b_{Pi}|)

where M is a scale factor. Next, CPU122 replaces 334 a value of |b_{Pi-1}| to be used for subsequent calculations of the zoom coefficient kᵢ and applied during processing of the next image frame captured by the second camera module 142, with the value of |b_{Pi}| determined at the current position i-.

According to one possible embodiment, the value of the scale factor M may be experimentally determined and introduced into the programmed applications 136 (FIG. 1) during the manufacturing of the portable imaging device 100. In another possible embodiment, the value of M may be simply changed by the user and yet, as part of another possible embodiment, if the portable imaging device 100 is capable of identifying its user, such portable imaging device 100 can overtime learn the value of the scale factor M and assign such scale factor to its individual users.

According to yet another possible embodiment, scale factor M may not have a constant value, but rather it may depend on how far the user moves the camera from its initial position. In this case it becomes a function f( ) of a variable |Δi| and may be expressed as

M=f(|Δᵢ|),

The type of the function f( ) used may be defined experimentally and pre-programmed during manufacturing of the portable imaging device 100 or as part of the aftermarket service. In any case, function f( ) reflects an ability of the portable imaging device 100 to adjust the speed with which the zoom function of the second camera module 142 is changed based on a degree the user's face or a facial feature being changed during the displacement of the portable imaging device 100. For example, in one potential embodiment, the scale factor M increases or decreases in value faster as the difference |Δᵢ| is increased or decreased respectively. One skilled in the art can easily recognize that any other suitable types of the function f( ) may be chosen.

Calculated value of the zoom coefficient kᵢ is received and saved 336 by the second camera module 142. Either digital or optical zooming techniques can be employed with the zooming coefficient. At block 338, the next image frame is captured by the second camera module 142 and if the automatic zoom mode is still enabled, conditional block 340 allows the second camera module 142 to apply 318 the zoom coefficient kᵢ to this captured image frame, subsequently displaying 320 said zoomed frame. Similar processing continues to be performed for all new image frames captured by the second camera module 142.

Returning to conditional block 330, if the calculated difference |Δᵢ| doesn't exceed the predetermined threshold T, which, for example, may correspond to a termination of the portable imagine device 100 movement relative to the user's head, CPU 122 maintains 332 the zoom coefficient unchanged for the second camera module 142 to be used for further processing 336. Alternative, if the zoom coefficient for the second camera module 142 remains unchanged, it does not have to be transmitted to the second camera module by CPU 122 allowing the second camera module 142 to continue using previously received value.

Method 300 continues processing until the user terminates the automatic zoom mode using the buttons 146, menu tools or other predefined touch or motion gestures. Once a termination command is received, CPU 122 resets the initial zoom coefficient to k₂=1for the second camera module 142, terminates 342 the automatic zoom mode, and continues to display captured images on the display 144 as part of viewfinder or preview modes.

As disclosed above, the automatic zoom algorithms implemented by the method 300 is directly tied to the size of the user's face with the zoom coefficient applied to the second camera module 142 being determined based on the relation of the face size determined at the current position of the portable imaging device 100 to the face size detected at its previous position. However, even though in certain cases automatic zooming can be performed faster with such approach, it becomes less stable due to continuous referencing to a constantly changing value of the distance between the eye pupil centers which may cause jumping of the displayed and recorded images as the portable imaging device 100 moves.

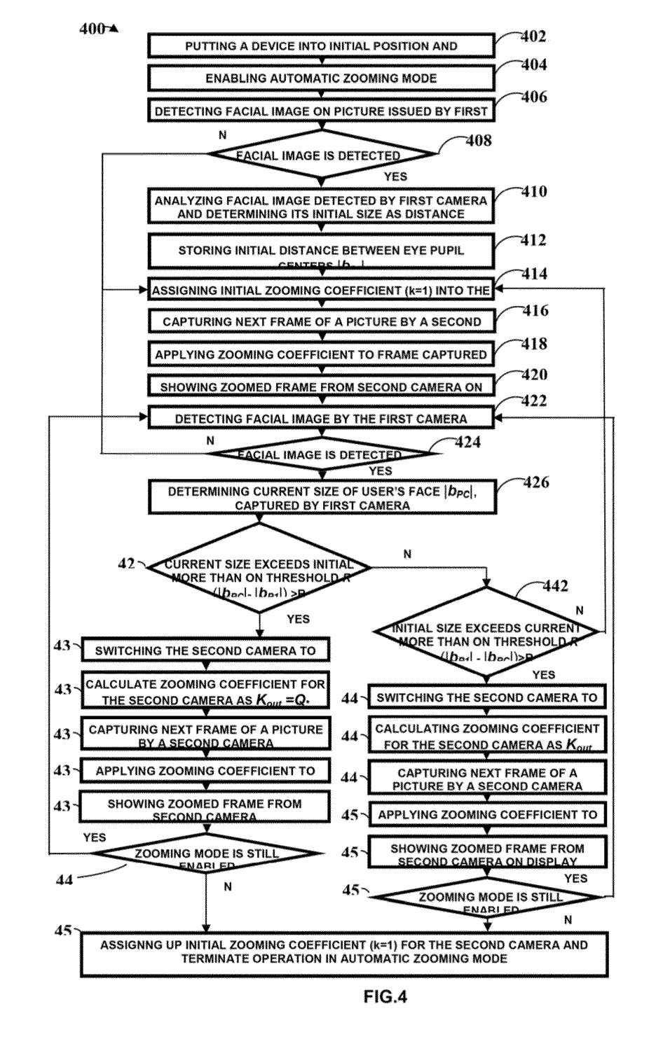

FIG. 4 illustrates a flow chart of another possible method 400 that partially overcomes this drawback and provides a more stable, but a bit slower zooming of an image provided by the back (second) camera module 142 using the facial image captured by the front (first) camera module 140.

Method 400 commences by placing the portable imaging device 100 into the desired initial position P1 (FIG. 2) and switching it on at block 402. Next, the user enables the automatic zoom mode at block 404 and CPU 122 begins detecting the user's face at block 406 by analyzing image frames captured by the first camera module 140. According to one possible embodiment, this may be done using appropriate program 136 stored in RAM 128. Particularly, this program may operate based on the well-known “AdaBoost” (Adaptive Boosting) algorithm (P.Viola and .M.Jones, “Robust real-time object detection,” In Proc. of IEEE Workshop on Statistical and Computational Theories of Vision, pp. 1-25. 2001) disclosed above and incorporated by reference herein.

When detection of the user's face is confirmed by the conditional block 408, CPU122 determines its initial size at block 410. According to one possible embodiment, the size of facial image may be represented by the modulus of vector b connecting eyes pupils' centers. This vector may be determined using an appropriate program 136 included “AdaBoost” algorithm mentioned above. In this case, at block 410, CPU 122 issues a value of the vector modulus |b_{P1}| corresponding to the distance between the eyes' centers in a facial image captured by the first camera module 140 once the portable imaging device 100 is placed at position P1. Then, CPU 122 keeps the value of the initial distance between the eyes pupils' centers |b_{P1| in the data storage 134 at block 412 and generates a corresponding control signal for controlling the zoom of the second camera module 142. Control signal may be generated in the form of RF, electrical, optical or other form oscillation and/or dc voltage, and comprises of information on the zooming coefficient to be applied to the second camera module 142 for processing the next captured frame.}

As the value of the vector modulus |b_{P1}| unequivocally defines the size of the user's face captured at the initial point P1 (FIG. 2), it therefore also corresponds to the initial zoom coefficient k₂=1 applied or as, signed to the second camera module 142 at block 414. Once the initial zoom coefficient is applied, the second camera module 142 is activated capturing the next image frame coming from its image sensor at block 416. Then, the image of this captured frame is appropriately scaled by applying the zoom coefficient k₂=1 at block 418 by the second camera module 142 under the control of CPU 122 and displayed at block 420 on the display 144.

Returning to the conditional block 408, if the facial image is not detected by the first camera module 140 for any reason, for example, due to shadowing or had lighting, or if capturing is performed using tripod and the user drifts out of its initial place, blocks 410 and 412 are skipped and the initial zoom coefficient k₂=1 is directly send to the second camera module 142 at block 414 and the image processing continues according to algorithm 400.

After displaying an initial frame of the captured image on the display 144 at block 420, method 400 returns to check the presence of the user's face in the field of view of the first camera module 140 at block 422. If the facial image is still absent then, the initial zoom coefficient of second camera module 142 remains unchanged at bock 414 and the loop continues to display zoomed image frames captured by the second camera module 142 on the display 144 at block 420.

Otherwise, CPU 122 determines the current size of user's face captured by the first camera module 140 at block 426 by measuring the current distance between the eyes pupils' centers |b_{PC}|, and compares such measured distance with the initially measured distance |b_{PC}|, stored at block 412 using two conditional blocks 428 and 442, or if the initial distance between the eyes pupils' centers has not yet been identified and stored, CPU 122 sets the initial distance |bP1| to equal the current distance |bPC|,

e.g. |bP1|=|bPC|. This processing is performed with the goal of determining whether or not the portable imaging device 100 has moved, and, if it did move, then in which direction it was moved and what was the range of such movement. The first thing being identified is whether the current size of the user's facial image or a facial feature exceeds its initial size by more than a threshold R. If condition 428

(|b_{PC}|−|b_{P1}|)>R

is satisfied, it means that the portable imaging device 100 was moved closer to the user so that his or her face or at least one facial feature was increased within the image captured by the first camera module 140. Consequently, the second camera module 142 is switched to a zoom-out mode of operation at block 430.

On the other hand, if the condition at block 428 is not satisfied, then it may be tested again at block 442 to determine whether the initial size of user's facial image exceeds the current size by more than the threshold R. If condition 442

(|b_{P1}|−|b_{PC}|)>R

is satisfied, it means that the potable imaging device 100 was moved further away from the user's head and, consequently, the second camera module 142 must be switched to a zoom-in mode of operation at block 444. However, one skilled in the art may easily recognize that a reverse zoom mode operation in both cases may be pre-programmed.

In the case when both conditional blocks 428 and 442 output a negative result, it is considered that the portable imaging device 100 remains stationary or has moved within the threshold range of (|b_{P1}|+R) and therefore, the second camera module 142 must receive the zoom coefficient k₂=1 at block 414 for further operation of capturing the next image frame at block 416 and displaying such captured and zoomed image on a display 144 at block 420. On the other hand, if the zoom coefficient has not changed, the second camera module 142 can simply continue to use its old zoom coefficient until request to change/adjust such coefficient.

Let us return to block 428 when a positive output of the conditional statement executed within this block is generated. As explained above, this decision switches the second camera into a zoom-out mode at block 430. Next, CPU 122 calculates the zoom coefficient kₒᵤₜ for the second camera module 142 at block 432 using the following formula

kₒᵤₜ=Q·(|b_{PC|-|b}_{P1}|),

where Q is a scale factor. According to one possible embodiment the value of the scale factor Q may be experimentally determined and introduced into programs 136 (FIG. 1) during the manufacturing of the portable imaging device 100. In other possible embodiment, the value of Q may be operatively changed by the user. A calculated value of kₒᵤₜ is transmitted to the second camera module 142 in the control signal to be applied at block 436 to the next image frame captured at block 434. (Alternatively, blocks 432 and 434 may be reversed in order as well.) Either digital or optical zooming techniques can be employed with the zooming coefficient on the next image frame. A zoomed image frame is then outputted and displayed on the screen of the display 144 at block 438.

After that, if the automatic zoom mode remains enabled, conditional block 440 transfers control to block 422 where the first camera module 140 tries to determine that the user's face or at least one of the facial features remain detectable. Consequently, objects located within the imaging frame captured by the second camera module 142 will continue to decrease in size, showing more and more environmental details around them until a minimal permitted value of the zoom coefficient kₒᵤₜ is reached. Once such minimum value for the zoom coefficient is reached, it will stay unchanged even as the user continues to move the portable imaging device 100 dose to his or her head.

If the conditional block 440 detects that the automatic zoom mode is switched off, CPU 122 terminates processing associated with the method 400, sets up an initial zooming coefficient for the second camera module 142 at block 456. In such a case, the last image frame captured by the second camera module 142 is processed with the initial zoom coefficient set to k₂=1 and subsequently is displayed on the display 144.

Now an alternative situation will be considered, where the conditional block 442 detects that the portable imaging device 100 has moved further away from the users face so that the condition

(|b_{P1}|−|b_{PC}|)>R

is satisfied. At block 444, the second camera module 142 is switched into a zoom-in mode of operation and the new zoom coefficient is calculated at block 446 for the second camera 142 by using the following formula

kᵢₙ=Q·(|b_{P1}|−|b_{PC}|),

where Q is a scale factor. According to one possible embodiment, the scale factor Q may have the same value as the scaling factor used during the zooming-out mode of operation of the second camera module 142. Obtained value of kᵢₙ is then transmitted to the second camera module 142 to be applied at block 450 to the captured image frame at block 448, therefore enlarging the objects of the captured image frame. Either digital or optical zooming techniques can be employed with the zooming coefficient to the next image frame. Then, the appropriately enlarged captured image is displayed on the screen of the display 144 at block 454.

Next, if the automatic zoom mode is still enabled, the algorithms implemented by the method 400 transitions to block 422, where, as explained above, the first camera module 140 is used to detect the facial image of the user's face. An operation inside this loop provides magnification of a picture captured by the second camera module 142 until a maximum permitted value of kᵢₙ is reached. After that, the image frame displayed on the screen of the display 144 will remain unchanged even if the user continues to move the portable imaging device 100 further away from his or her head.

If the conditional block 454 detects that the automatic zoom mode is switched off, the CPU 122 sets up the initial zoom coefficient for the second camera module 142 and terminates processing associated with the method 400 at block 456. Similar to what was already described above, the last frame captured by the second camera module 142 will be processed with the initial zoom coefficient of k₂=1 and displayed on the screen of the display 144,

Due to a direct reference of the current zoom coefficient to a stable value of the initial distance of the eyes pupils' centers |b_{P1}| which does not change from frame to frame, the method 400 provides an improved stability when processing captured images to be displayed on the screen of the display 144.

CPU 122 may also provide tracking of the user's face and provide an indication to the user that his face is moving out of the field of view. When the user's face is out of the field of view, automatic zooming may terminate and the display 144 will provide a feedback to the user of the final zooming coefficient that was applied to the second camera module. When the face is detected again within the field of view, the CPU 122 can retain the zooming coefficient as previously determined and applied before the user's face left the field of view of the first camera module; or the CPU 122 can also reset the zooming coefficient to 1×, and continue with either of the example methods described in FIGS. 3 and 4 above. Different colors, brightness, tonalities, animations, and sounds, for example, may used as indications of tracking ability for the facial image or facial feature.

Notably, a portion display screen can be dynamically highlighted or animated to inform the user of his facial alignment relative to the field of view of the first camera module.

Gestures involving moving a hand across the user's face may be detectable and analyzed by CPU 122 to reset zooming coefficient to 1× zoom, for example. In addition, maximum optical zooming may also be accomplished by predetermined gestures, including moving a hand across the face (i.e., a motion gesture relative to the first camera module). Also, various touch gestures relative to the display screen of display 144 may be sensed and analyzed by CPU 122 to adjust the zooming operation,

Although preferred embodiments are illustrated and described above, there are possible combinations using other structures, components, and calculation orders for performing the same methods of using images captured by one camera module for zooming video or photo, recorded by the other camera or cameras. Embodiments disclosed herein are not limited to the above methods and should be determined by the following claims. There are also numerous applications in addition to those described above. Many changes, modifications, variations and other uses and applications of the subject invention will become apparent to those skilled in the art after considering this specification and the accompanying drawings which disclose preferred embodiments thereof. AD such changes, modifications, variations and other uses and applications which do not depart from the scope of the described teachings are deemed to be covered by the invention which is limited only be the following claims.

I claim:

1. The method for obtaining zoomed images with a portable imaging device equipped with a plurality of video cameras, comprising:
enabling in the portable imaging device an automatic zooming mode in which a first camera and, at least a second camera within the portable imaging device are accessed to obtain images from a correspondent field of view associated with each camera;
detecting a facial feature in a first image obtained by the first camera of the portable imaging device while the first camera is disposed in an initial position;
determining an initial size of the detected facial feature;
assigning a zooming coefficient corresponding to the initial size of the detected facial feature to, at least, the second camera; capturing a frame of a second image obtained by, at least, the second camera;
applying the zooming coefficient to the captured frame of the second image; and
displaying the zoomed frame of the second image on a display screen of the portable imaging device.

2. The method according to claim 1, further comprising:
determining a current size of the detected facial feature obtained by the first camera of the portable imaging device as positioned in a current position;
comparing the current size of the detected facial feature with previously determined size of the facial feature.

3. The method according to claim 2, wherein the current size of the detected facial feature differs from the previously detected size of the facial feature by more than a threshold T calculating a next zooming coefficient as a ratio of current size to the previous size for the facial feature.

4. The method according to claim 2, wherein the next zooming coefficient remains unchanged if the current size of detected facial feature differs from the previously detected size of the facial feature by less than the threshold T.

5. The method according to claim 3, further comprising:
applying a calculated zooming coefficient to an image frame captured by, at least the second camera; and
displaying a zoomed image frame on the display screen of the portable imaging device.

6. The method according to claim 4, further comprising:
applying a calculated zooming coefficient to an image frame captured by, at least the second camera; and
displaying a zoomed image frame on the display screen of the portable imaging device.

7. The method according to claim 1, wherein the initial size of the detected facial image is stored in memory for subsequent comparison with a current size of the detected facial image.

8. The method according to claim 1, wherein the zooming coefficient causes a minimal zoom.

9. The method according to claim 1, wherein the zooming coefficient is additionally based on one of preset value, a learned value, or a zoom range as is indicated by a user.

10. The method according to claim 1, wherein the zooming coefficient is assigned to the second camera based on a direct relationship between current size of a captured facial image from the first camera and a zooming ratio corresponding to an initial position of the portable imaging device.

11. A portable imaging device, comprising:
a housing enclosing a lens assembly,
a processing unit,
a first camera module,
a second camera module and,
a display having a display screen and communicatively coupled with the first and second camera modules over a data bus; wherein the processing unit is configured to assign a zooming coefficient corresponding to an initial size of a detected facial feature to, at least, the second camera module;
applies the zooming coefficient to a captured frame of an image from the second camera module; and
enables display of a zoomed frame of the second image on the display screen of the portable imaging device.

12. The portable imaging device of claim 11, wherein both camera modules are arranged to obtain both still images and video.

13. The portable imaging device of claim 11, wherein the first camera module is arranged in such manner that its lens is disposed on the same one cover of portable imaging device housing with the display.

14. The portable imaging device of claim 13 wherein the lens of the first camera and display is mutually directed in such a manner that user can simultaneously watch on a picture showed on display and be attendant in the field of view of the first camera lens.

15. The portable imaging device of claim 11, wherein the image captured by second camera is magnified on display screen if portable imaging device moves in direction to user's head and vice versa.

16. The portable imaging device of claim 11, wherein size of the facial feature image is defined by module of vector, connecting eye pupil centers.

17. The portable imaging device of claim 1 wherein zooming coefficient for the at least second camera is calculated by formula
kᵢ=M*(|bₚᵢ₋₁|/|b_{Pi}|),
where |b_{Pi}| and |b_{Pi-1}| are the modules of vector connected eyes pupil centers on facial image captured by the first camera in current and previous position and M is scale factor of constant value.

18. The portable imaging device of claim 11, wherein the value of scale factor M is dependent on how far portable imaging device is moved from initial position during zooming.

19. The portable imaging device of claim 11, wherein value of zooming coefficient for, at least, second camera remains equal to initial magnitude until the first camera detects facial image.

20. The portable imaging device of claim 11, wherein value of zooming coefficient for, at least, second camera reminds unchanged when facial image disappears from the field of view of the first camera.

21. A method for zooming images obtained by camera of portable imaging device equipped with plurality of video cameras based on difference of face size captured in current and initial positions, comprising:
putting a portable imaging device into initial position at front of user, the portable imaging device including:
a first camera module positioned to obtain images from an area disposed between portable imaging device and the user, the images including user's facial image;
at least one second camera module positioned to obtain images from the area disposed at front of the user beyond the portable imaging device;
at least one processing unit to provide real-time processing images captured by the first and other cameras;
a display arranged to show images captured by cameras to the user under control of processing unit;
enabling in a portable imaging device an automatic zooming mode in which the first and, at least, the second camera modules are switched on simultaneously and obtain images from their correspondent field of view;
detecting facial image in the image obtained by the first camera of portable imaging device disposed in initial position;
determining and storing initial size of detected facial image;
setting up initial zooming coefficient corresponded to initial size of detected facial image into, at least, the second camera;
capturing the next frame of an image obtained by, at least, the second camera;
zooming the next frame of an image obtained by, at least, the second camera with initial zooming coefficient;
showing zoomed frame from, at least, the second camera on display;
detecting facial image in the image obtained by the first camera of portable imaging device disposed in current position;
determining and storing current size of detected facial image;
comparing current size of detected facial image with previously stored one;
switching the second camera to zoom out mode if current size of detected facial image exceeds initial one more than on threshold R, otherwise,
checking up whether the initial size of detected face exceeds current size more than on threshold R and, if yes, switching the second camera to zoom in mode, otherwise
setting up initial zooming coefficient corresponded to initial size of detected facial image into, at least, the second camera;
calculating zooming coefficient for, at least the second camera switched on in zoom out mode;
capturing next frame of a picture by the second camera;
zooming captured frame using calculated coefficient;
showing zoomed frame on a display;
checking up whether the zooming mode is still enabled and, if yes, repeat operational procedure for zoom out mode with new size of facial image detected by first camera, otherwise,
setting up initial zooming coefficient for the second camera and terminating operation in automatic zooming mode;
calculating zooming coefficient for, at least the second camera switched on in zoom in mode;
capturing next frame of a picture by the second camera;
zooming captured frame using calculated coefficient;
showing zoomed frame on a display;
checking up whether the zooming mode is still enabled and, if yes, repeat operational procedure for zoom in mode with current size of facial image detected by first camera, otherwise,
setting up initial zooming coefficient for the second camera and terminating operation in automatic zooming mode.

22. The method of claim 21, wherein zooming coefficient for the, at least, second camera operated in zoom out mode, is calculated by formula
kₒᵤₜ=Q·(|b_{PC}|−|b_{P1}|),
where |b_{PC}| and |b_{P1}| are the modules of vector connected eyes pupil centers on facial image captured by the first camera in current and initial position and Q is scale factor of constant value.

23. The method of claim 21, wherein zooming coefficient for the, at least, second camera operated in zoom in mode, is calculated by formula
kᵢₙ=Q*(|b_{P1}|−|b_{PC}|),
where |b_{PC}| and |b_{P1}| are the modules of vector connected eyes pupil centers on facial image captured by the first camera in current and initial position and Q is scale factor of constant value.
